(19) United States
(12) Patent Application Publication
(10) Pub. No.: US 2026/0049687 A1
(43) Pub. Date: Feb. 19, 2026

(54) STORAGE DEVICE FOR A FASTENING DEVICE FOR FIXING A STORAGE BODY

(71) Applicant: Schwäbische Werkzeugmaschinen GmbH, Schramberg-Waldmössingen (DE)

(72) Inventors: Thomas FONTAINE, Niedereschach (DE); Damian MARMOL, Chelmiec (PL); Jianjun GAO, Suzhou (CN)

(21) Appl. No.: 19/298,842

(22) Filed: Aug. 13, 2025

(30) Foreign Application Priority Data
Aug. 15, 2024 (EP) 24194786.0

(51) Int. Cl. F16M 13/02

(52) U.S. Cl. CPC F16M 13/02

(57) ABSTRACT

A storage device for fixing a storage body, with at least one table or panel-like storage medium including a storage surface, on which a storage body can be freely fixed to the fastening unit. A number of recesses transverse to the storage surface can be accessed from the storage surface, in which at least one of the retaining bolts can be moved transversely which can be fixed in a basic position in which the retaining bolt continuously continues the support surface of the support means with an externally accessible end face of a head section of the retaining bolt or springs back in the direction of the recess with respect to the support surface, and which can be transferred and fixed into a holding position which a coupling region of the head section for fastening one of the at least one fastening unit thereto is accessible from the outside.

### CROSS-REFERENCE

This application claims the benefit of European application EP 24194786.0 filed Aug. 15, 2024, which is incorporated herein by reference.

The invention relates to a storage device for a fastening device for fixing a storage body.

Storage devices for depositing and fixing storage bodies are known from the state of the art in different variations. In these, the storage device comprises a table or panel-like storage medium, on which a storage body can be deposited. For detachable fixing of the storage body deposited on the storage medium, known storage devices include fastening units, which can be fixed on the storage medium. The fastening units can then in turn clamp the storage body to the storage device using interlocking or force-locking.

In the known storage devices, it has proven disadvantageous that the fastening units must be fixed by laboriously screwing them to the storage medium. Furthermore, it is only possible to place the fastening units on the storage device at certain designated places.

### SUMMARY

The object of the embodiment of the invention is to propose a storage device for a fastening device for fixing a storage body, whereby a fastening unit can be easily fixed to the storage medium.

This object is achieved by a storage device for a fastening device for fixing a storage body, with at least one table or panel-like storage medium comprising a storage surface, on which a storage body and/or a storage body on the storage medium can be freely fixed to the fastening unit, and comprises a number of recesses transverse to the storage surface and which can be accessed from the storage surface, wherein at least one of the retaining bolts in at least one of the recesses can be moved transversely to the storage surface along a transfer direction, which can be fixed in a basic position in which the retaining bolt continues the deposit surface of the deposit means with an externally accessible end face of a head section of the retaining bolt in a stepless manner or springs back in the direction of the recess with respect to the storage surface and which is transferable and determinable in its holding position, in which the head section of the retaining bolt of the storage surface protrudes from the recess and in which a coupling point of the head section is accessible from outside for determining at least one fastening unit.

The fact that the storage device comprises multiple recesses in the storage medium, wherein at least one retaining bolt can be arranged in each recess, which can be transferred from the basic position to the holding position, enables a coupling option to be added to the fastening unit in a simple manner in order to fix the fastening unit to the storage medium. In particular, this means that laborious screwing is not necessary.

Since the retaining bolts in the basic position are stored in the storage device in such a way that they do not extend beyond the storage surface, the retaining bolts can only be transferred to the holding position at the points at which a fastening unit is to be fixed. In the remaining areas, storage bodies can be stored unhindered.

Furthermore, as a result of the many recesses and retaining bolts therein, storage bodies of various dimensions can be arranged and fixed in a simple manner to the table or panel-like storage device.

For example, the storage body may include a module, component or workpiece.

The table or panel-like storage device may be designed such that it is temporarily or permanently fixed, for example, at a machine tool, or so that it can be grasped and transported manually by an operator or robot for the safe transport of the storage body.

The arrangement of the majority of recesses is typically arbitrary. It is advantageous if the majority of recesses in the table or panel-like storage device are equally opposed to each other transversely to the transfer direction and are distributed in a grid-like manner.

The fact that the recesses in the storage device are evenly spaced to each other and, in particular, are distributed in a grid-like manner, allows an even, homogeneous distribution of the recesses over the storage surface of the holding means. By arranging the retaining bolts in the recesses, this enables various ways of fixing the fastening units to the storage device.

Two recesses can have a relatively arbitrary distance to each other, provided that the technical function is fulfilled that fastening units for fixing multiple storage bodies can be arranged.

In embodiments of the storage device, it is preferred if two recesses have a maximum distance of 50 mm to each other, in particular a maximum of 40 mm to each other, in particular a maximum of 35 mm to each other, in particular a maximum of at least 30 mm to each other. This provides a close-knit arrangement of retaining bolts and thus of fastening units.

In order to ensure that at least one of the retaining bolts which is arranged in at least one of the multiple recesses is arranged in the respective recess in a manner that is safe from loss, it is advantageous if the storage device comprises at least one stop unit which is arranged together with a retaining bolt in one of the recesses and by which movement of the retaining bolt along, in and opposite to the transfer direction can be limited.

In a further development of the latter embodiment, it is advantageous if the stop unit comprises an annular body arranged in the recess and/or if movement of the retaining bolt from the direction of the supporting surface into the recess is limited by the head section on the side facing the supporting surface of the annular body, if the retaining bolt comprises a sliding section adjacent to the head section, which has an outer surface that rebounds with respect to the head section and whose diameter is perpendicular to the inner diameter of the head section of the annular body, and if the retaining bolt comprises a foot section that is temporarily or permanently fixed to the head section of the end of the sliding section, whose diameter perpendicular to the guiding direction is greater than the inner diameter of the annular body and sits in the head section of the side of the annular body facing away in its holding position.

If the stop unit comprises an annular body arranged in the recess, each of the multiple recesses can be equipped with a stop unit by arranging an annular body. This allows the storage device to be easily implemented technically by inserting the recesses into the storage device, in particular through continuous holes, for example.

If the retaining bolt comprises a head section and a foot section, the retaining bolt can be moved within the recess until the head section or foot section stops.

The fact that the foot section can be temporarily fixed to the retaining bolt makes the storage device easier to assemble. In such a case, the retaining bolt can be arranged alone or together with the annular body in the recess or, if the annular body is already arranged in the recess, inserted when arranging the retaining bolt through the annular body and the foot section on the side of the storage device facing away from the storage surface is inserted into the recess and fixed to the retaining bolt.

In this case, the foot section comprises a component that is separate or separable from the retaining bolt.

In order to guide a movement of the retaining bolt along the transfer direction, that is, in the same or opposite transfer direction, one embodiment of the storage device comprises at least one slotted guide system with a slot formed by at least one groove on the retaining bolt, in particular on the sliding section of the retaining bolt, and which comprises at least one pin-like projection fixed in the recess and which engages in the slot, in particular wherein the pin-like projection on the annular body, in particular on the side facing the sliding section of the retaining bolt, is fixed.

The slotted guide system allows the retaining bolt to be moved.

The slotted guide system enables the retaining bolt to be adjusted and set up in different positions, and the retaining bolt can be arranged and fixed at these positions alternatively or in combination with the stop unit.

In one embodiment of the storage device, the slot formed by at least one groove is arranged on the sliding portion of the retaining bolt. In such a case, it can be advantageous if the pin-like projection on the annular body, in particular on the side of the annular body facing the sliding section of the retaining bolt, is fixed in place.

In a further development of the latter embodiment, the slotted guide element of the stop unit, wherein the pin-like projection is arranged in its starting position on the slot and the retaining bolt is held against moving in the direction of the recess, wherein the retaining bolt for releasing the pin-like projection from the starting position can be moved in the direction of the recess and guided in a releasing area of the slot, wherein the retaining bolt can be moved to arrange the pin-like projection in a stop position along the slot in the direction of the recess and wherein the retaining bolt can be moved to arrange the pin-like projection on the starting position towards the recess until an estimate basic position has been reached and can be moved from the estimate basic position towards the recess until the basic stop position has been reached.

The groove-like slot may have several branches for accessing the different positions, which can be positioned by actuating the retaining bolt and thereby initiating a relative movement between the retaining bolt and pin-like projection to release the retaining bolt from its position.

The retaining bolt can be released from the initial position by moving the retaining bolt in the direction of the transfer, from the direction of the storage surface towards the storage device, and can be guided into the release area within the slot. The retaining bolt is immersed in the recess as far as possible. In the release area itself, the retaining bolt with the pin-like projection can form a stop or the pin-like projection can be positioned in the slot without any contact, wherein the retaining bolt with its head section sits against the annular body.

During the subsequent movement of the retaining bolt against the transfer direction, i.e. in the direction of the storage surface, away from the recess, the retaining bolt is moved in such a way that the pin-like projection is located in the holding position area of the slot. Here, the pin-like projection with the slot can form a stop and/or the retaining bolt with its foot portion can sit against the annular body, wherein the pin-like projection is positioned in the slot without any contact.

When the retaining bolt is actuated again by moving in the transfer direction, i.e. from the storage surface towards the recess, the pin-like projection is not transferred back into the release area, but via a branch in the direction of the estimate basic starting position. When the estimate basic starting position is reached, a stop is formed that blocks further movement of the retaining bolt into the recess. When the retaining bolt is moved out in the opposite direction of the transfer direction, i.e. from the storage surface away from the recess, the pin-like projection is guided back into the starting position stop and fixes the bolt here against movement in the opposite direction to the transfer direction.

It is fundamentally conceivable that the majority of recesses include counterbores in the storage medium, i.e. are not continuous.

For positioning and fixing the retaining bolt and annular body, it is advantageous if at least one of the multiple recesses runs through the panel body and/or if the retaining bolt comprises a cavity extending parallel to the transfer direction, which is accessible from the outside via an opening on the opposite end of the retaining bolt to the head section.

In order to reduce the risk of dirt and moisture penetrating the latter embodiment, a further development of the latter embodiment comprises a substantially closed surface comprising a floor plate with a closed surface transverse to the transfer direction, which can be temporarily or permanently fixed to the table or panel-like storage device on the opposite side of the storage device and by which at least one of the multiple recesses on the side of the plate body facing away from the contact surface is closed in whole or at least in sections to the outside.

In order to facilitate a transfer of the clamping bolt to the individual positions, one embodiment of the storage device comprises at least one mechanically, electrically, electromagnetic, pneumatically and/or hydraulically effective clamping device, which can be arranged in a recess together with a retaining bolt and through which the retaining bolt is clamped in the holding position.

By positioning the clamping device, the clamping bolt must always be moved in the direction of the recess along the transfer direction against the spring force.

In a further development of the latter embodiment, it is advantageous if the clamping device comprises a spring which is supported with one end on the base plate and the other end on the retaining bolt, in particular where the end supported on the retaining bolt is positioned in the opening of the retaining bolt.

By providing the clamping device, the clamping bolt is easily retracted manually or by a manipulator, such as a robot, in the storage device and positioned by pressing in the direction of the transfer direction either in the holding position or the starting position.

This can be moved in a simple manner, namely by pressing in the direction of the transfer direction at the points on the storage device, where a retaining bolt moves out from the recess by the clamping device on which a fastening unit is to be provided.

This makes it possible to use the storage device without using any tools.

In order to ensure easy fixing of the fastening unit onto the retaining bolt, it is advantageous if the coupling point of the head section of the retaining bolt comprises at least a rotationally symmetrical, rear grip region, which is formed by a recess transverse to the transfer direction in which the outer surface of the head region is parallel or oblique to the transfer direction.

This allows the retaining bolt to be interlocked in the holding position by the fastening unit. This allows the fastening unit to be fixed to the storage means with an increased force and itself fix the storage body to the storage means with an increased force.

In principle, it is conceivable that a retaining bolt is positioned in each of the multiple recesses. However, placement states of the storage device are also conceivable, in which at least one of the multiple recesses is designed to be free of retaining bolts. In order to prevent the ingress of dirt and moisture, it is thus advantageous if the storage device has at least one plug-like closure element that can be positioned in the recess, which closes the recess from the direction of the storage surface outwards in the assembled state and which continues freely in the assembled state of the storage surface of the storage means with a closure surface accessible from the outside or jumps back in the direction of the recess with respect to the storage surface.

In order to facilitate actuation of the retaining bolt and/or locking element in the starting position, it is advantageous if the locking element on the locking surface and/or if the head section of the retaining bolt on the end face comprises a recess with a rounded or angular cross-section with respect to the transfer direction, and into which a tool for manual or automatic actuation can be inserted.

This simplifies gripping and actuating the locking element or the retaining bolt.

It is fundamentally conceivable that the retaining bolt with its end surface and/or the locking element with its locking surface, continues into the storage surface seamlessly and/or continuously. However, embodiments may also be provided in which the locking element with its closure surface or the retaining bolt with its end surface is arranged offset in the direction of the recess in its starting position. In such a case, it may be advantageous if the storage device comprises at least one plug element, which can be positioned in the recess in the end face of the head section of the retaining bolt and/or in the recess in the closure surface of the locking element and which allows the end face or the closure surface with an end portion to continue seamlessly in the direction of recess and/or if the storage device comprises at least one cover element that can be positioned in the recess in the end face of the head section of the retaining bolt and/or in the recess in the closure surface of the locking element and which sits fully or in part transversely to the transfer direction.

Through the plug element and/or through the cover element, an uneven surface of the end surface of the head section of the retaining bolt or the closure surface of the locking element can be covered or concealed outwardly.

In order to reduce the risk of ingress of dirt and moisture, a further development of the storage device comprises at least one sealant which can be closed in the recess, in particular on a region adjacent to the storage surface, which is arranged on the head section of the retaining bolt and/or the locking element, and through which a gap between the retaining bolt and recess or between the locking element and recess and/or wherein a further development of the storage device comprises at least one pressure unit whose fluid passage leads into at least one recess, and through which the fluid introduced via the fluid passage in the recess can be pressurised.

Further features, details and advantages of the invention are apparent from the attached patent claims, the drawing and the following description of a preferred embodiment of the storage device.

### BRIEF DESCRIPTION OF THE DRAWINGS

The drawing shows:

FIG. 1 a sectional view through a region of an invented storage device for a fastening device;

FIG. 2 a perspective top view of a storage means of the storage device according to FIG. 1;

FIG. 3 a perspective view of the storage means according to FIG. 2;

FIG. 4 a side view of a retaining bolt with clamping device arranged in an annular body;

FIG. 5 a side view of the retaining bolt according to FIG. 4 in the starting position;

FIG. 6 a side view of the retaining bolt according to FIG. 4 in the release position;

FIG. 7 a side view of the retaining bolt according to FIG. 4 in the holding position;

FIG. 8 a sectional view through a retaining bolt in the recess of the storage means in the starting position;

FIG. 9 a sectional view through a retaining bolt in the recess of the storage means in the holding position;

### DETAILED DESCRIPTION

The figures show different representations, in particular detailed representations, of a storage device for a fastening device 4 for fixing a storage body (not shown in the figures), represented overall as reference 2. The storage device 2 comprises a table or panel-like storage means 6, which comprises a storage surface 8, on which a storage body (not shown in the figures) and/or a fastening unit 10 can be temporarily fixed to the storage means 6.

The storage device 2 comprises multiple recesses 12 in the storage means 6, which are transversely extended to the storage surface 6 and which are accessible from the outside from the storage surface 8.

In addition, the storage device 2 comprises multiple retaining bolts 14, wherein at least one of retaining bolts 14 in at least one of the recesses 12 is freely movable along a storage surface 8 transverse to the transfer direction 16.

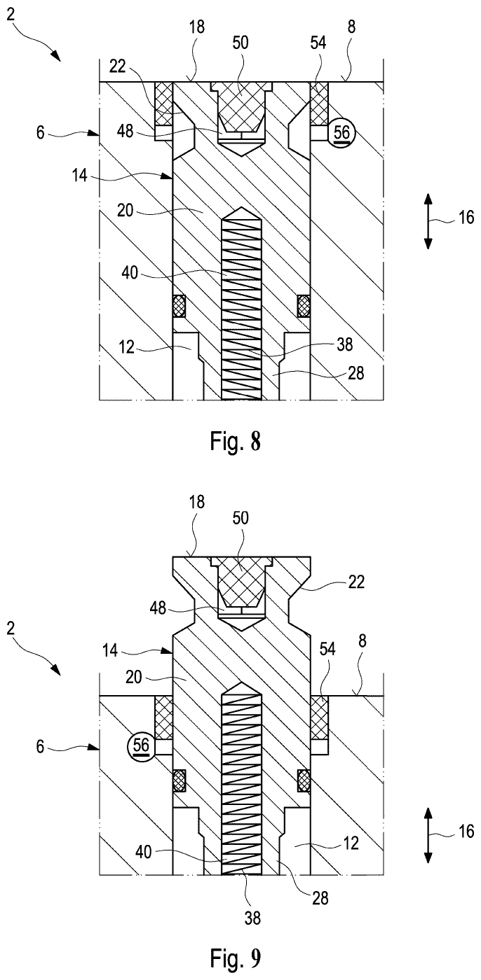

A retaining bolt 14 can be fixed in a starting position (FIG. 8), in which the retaining bolt 14 freely continues the storage surface 8 of the storage means 6 with an externally accessible end surface 18 of a head section 20 of the retaining bolt 14. In addition, the retaining bolt 14 can also jump back to the starting position in the direction of recess 12 with respect to the storage surface 8.

The retaining bolt 14 may be transferred in a holding position (FIG. 9), in which the head section 20 of the retaining bolt 14 protrudes from the recess 12 with respect to the storage surface 8 and in which a coupling point 22 of the head section 20 of the retaining bolt 14 for fixing onto at least one fastening unit 10 is externally accessible.

In the embodiment of the storage device 2 visible in the figures, the coupling point 22 is formed by a rear grip region, which is formed by a recess transverse to the transfer direction 16 in which the outer surface of the head region 20 is parallel or oblique to the transfer direction 16.

A stop unit 24 is arranged in the recesses 12. The stop unit 24 is in such a case always arranged together with a retaining bolt 14 in one of the recesses 12. The stop unit 24 may comprise an annular body 26 which is fixed in the embodiment shown in the figures within the recess 12. A retaining bolt 14 engages the annular body 26 with a sliding section 28, which is formed on the head section 20 subsequently on the retaining bolt 14, and comprises a smaller diameter than the head section 20. The sliding section 28 comprises in particular a diameter which is formed correspondingly, in particular complementarily, to the inner diameter of the annular body 26.

The movement of the retaining bolt 14 is limited in this case within the recess 12 by fastening the head section 20 of the retaining bolt 14 to the annular body 26.

On the side of the retaining bolt 14 facing away from the head section 20, a foot section 30 is fixed at the end of the sliding section 28. The foot section 30 can be temporarily fixed to the retaining bolt 14 and limits movement of the retaining bolt in the direction away from the recess 12 by fastening the foot section 30 on the storage surface 8 facing away from the side of the annular body 26 in the holding position.

In the embodiment shown in the figures, the stop unit 24 also comprises a slotted guide system 32, which comprises a slot 34 formed by at least one groove on the retaining bolt, in particular on the sliding section 28 of the retaining bolt 14, and by a pin-like projection 36, which is fixed to the annular body 26 in the embodiment shown in the figures.

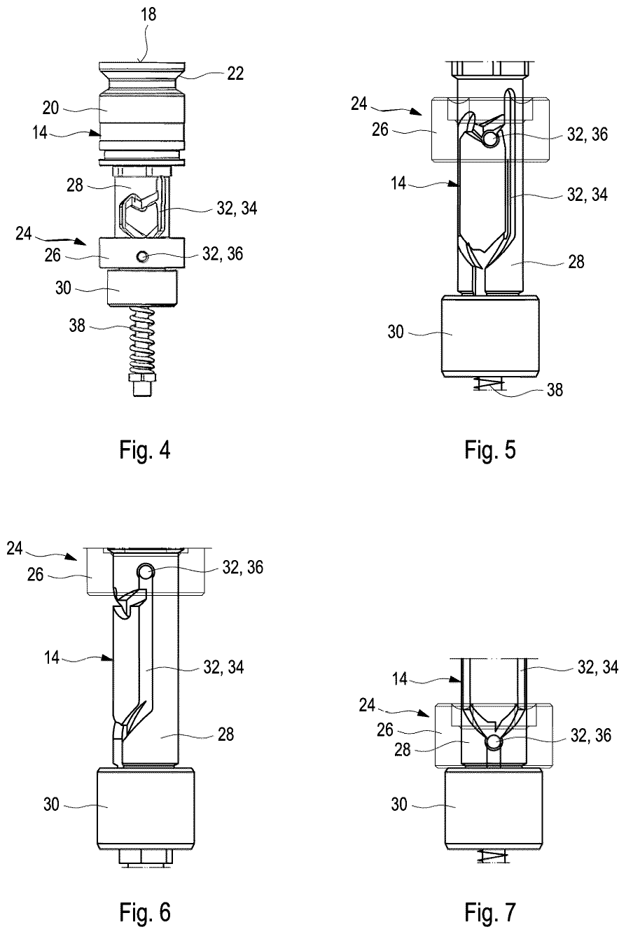

FIGS. 4 to 7 show a representation of the retaining bolt 14 with foot section 30 and with slotted guide system 32 and annular body 26. FIGS. 5 to 7 are hereby exclusively related to the sliding section, whereas FIG. 4 still represents a representation of the retaining bolt 14 along with the head section 20.

From FIGS. 4 to 7 it can be seen that when the retaining bolt 14 is arranged in a starting position (FIG. 5), the pin-like projection 36 is arranged at a starting position stop of the slot 34 and the retaining bolt 14 is thereby prevented from moving in the direction away from the recess 12.

By moving the retaining bolt 14, the pin-like projection 36 within the slot 34 moves relatively, so that the pin-like projection 36 is located in a release region of the slot 34 (FIG. 6).

By moving the retaining bolt 14 parallel to the transfer direction 16 away from the recess 12, the pin-like projection 36 is arranged in a holding position region of the slot 34. The foot section 30 is thus flat against the annular body 26 and limits the movement of the retaining bolt 14 further out of the recess 12. By moving the representation again according to FIG. 7 parallel to the transfer direction 16 in the direction of recess 12, the pin-like projection 36 is then arranged again via a parallel branch in the slot 34 at the base position stop according to FIG. 5.

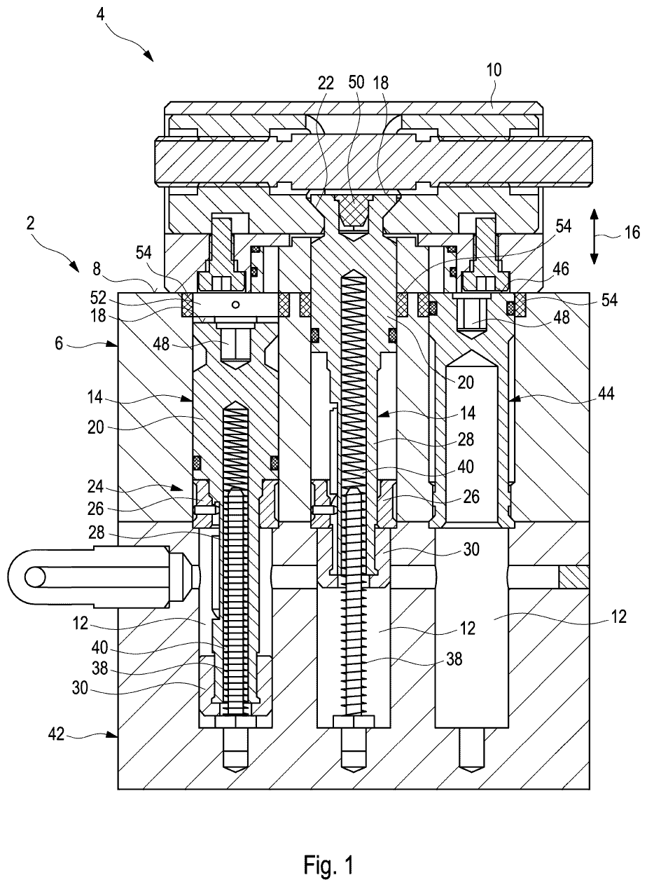

In addition, it can be seen in FIGS. 1, 4, 8 and 9 that the storage device 2 in the embodiment shown in the figures comprises a mechanically effective clamping device 38, which is formed by a spring. The clamping device 38 clamps the retaining bolt 14 in the holding position (shown in FIG. 1 middle retaining bolt 14, as well as FIG. 7 and FIG. 9). The clamping device 38 is arranged within the retaining bolt 14 in an opening 40 of the retaining bolt 14. The opening 40 is located on one side of the retaining bolt 14 opposite to the storage surface 8.

In order to support the clamping device 38, the storage means 6 comprises a closed surface with a base plate 42, which can be temporarily fixed to the storage means 6. This makes it possible to form the recesses 12 continuously and to arrange the retaining bolts 14, annular body 26, foot section 30 and clamping device 38 in the recess 12 and then to close through the base plate 42.

A retaining bolt 14 does not necessarily need to be arranged in every recess 12 of the storage means 6. A recess 12 can also be closed by a plug-like locking element 44. In the recess 12 arranged state of the locking element 44, this continues with a closure surface 46 on the storage surface 8 of the storage means 6 or jumps back with respect to the storage surface 8 in the direction of recess 12.

FIGS. 1 and 8 show that in the closure surface 46 of the locking element 44 and/or in the end surface 18 of the head section 20 of the retaining bolt 14, a recess 48 may be arranged, which may comprise a rectangular cross-section with respect to the transfer direction 16. Thereby, a tool for manual or automatic actuation can be easily inserted into the recess 48 and the locking element 44 and/or the retaining bolt 14 are actuated. At the recess 48, a plug element 50 may be provided (FIG. 8 and FIG. 9), through which the recess 48 can be closed. In addition, a cover element 52 can be arranged in the recess 48, which covers the recess and the end surface 18 of the retaining bolt 14 and/or the recess 48 and the closure surface 46 of the locking element 44 and the storage surface 8 continues freely.

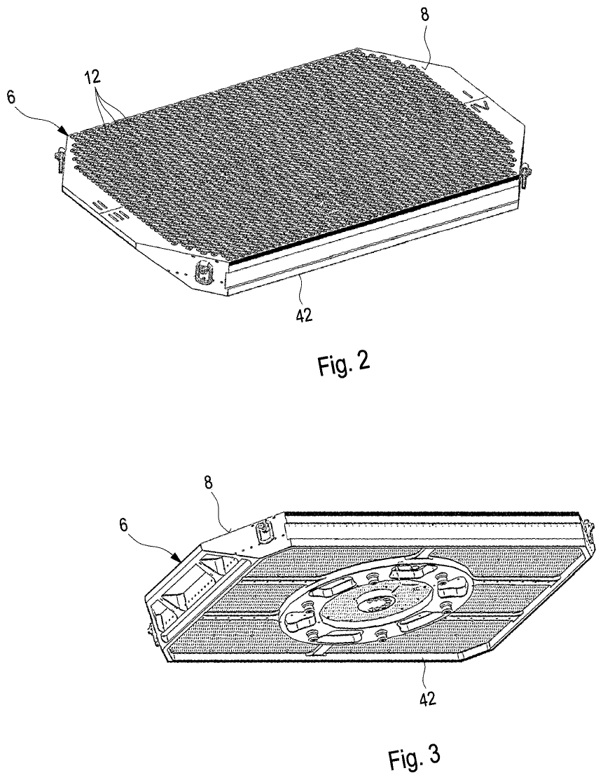

FIG. 2 shows a representation of the storage means 6. From FIG. 2 it can be seen that the majority of recesses 12 are evenly distributed to each other over the storage surface 8.

FIGS. 8 and 9 show a detailed view of the storage device 2 in the transition area of the recess 12 into the storage surface 8. From FIGS. 8 and 9 it is apparent that a sealant 54 can be positioned in each recess 12. In order to counteract the ingress of moisture or contamination, a pressure unit 56 may also be provided, which opens with a fluid passage in at least one recess 12 and through which the fluid introduced via the fluid passage in the recess 12 can be pressurised.

The features of the invention disclosed in the above description, in the claims and in the drawing may be essential for the realisation of the invention in its various embodiments, both individually and in any combination, within the scope of the following claims.

### REFERENCE SYMBOL LIST

2 Storage device
4 Fastening device
6 Storage medium
8 Storage surface
10 Fastening unit
12 Recess
14 Retaining bolts
16 Transfer direction
18 End face
20 Head section
22 Coupling point
24 Stop unit
26 Annular bodies
28 Sliding section
30 Foot section
32 Slotted guide system
34 Slot
36 Projection
38 Clamping device
40 Opening
42 Base plate
44 Locking element
46 Locking surface
48 Recess
50 Plug element
52 Cover element
54 Sealant
56 Overpressure unit

1. A storage device for a fastening device for fixing a storage body, with at least one table or panel-like storage medium comprising a storage surface, on which a storage body and/or a storage body on the storage medium can be freely fixed to the fastening unit, and comprises a number of recesses transverse to the storage surface and which can be accessed from the storage surface, wherein at least one of the retaining bolts can be moved transversely to the storage surface along at least one recess via a transfer direction which can be fixed in a basic position in which the retaining bolt continuously continues the support surface of the support means with an externally accessible end face of a head section of the retaining bolt or springs back in the direction of the recess with respect to the support surface, and which can be transferred and fixed into a holding position in which the head section of the retaining bolt protrudes from the recess with respect to the support surface and in which a coupling region of the head section for fastening one of the at least one fastening unit thereto is accessible from the outside, wherein at least one mechanically, electrically, electromagnetic, pneumatically and/or hydraulically effective clamping device, which can be arranged in a recess together with a retaining bolt and through which the retaining bolt is clamped in the holding position.

2. The storage device according to claim 1, wherein the majority of recesses in the storage medium transverse to the transfer direction are equally opposed to each other and are distributed in a grid-like manner.

3. The storage device according to claim 1, wherein at least one stop unit is arranged together with a retaining bolt in one of the recesses and by which movement of the retaining bolt along the transfer direction in and against the transfer direction is limited.

4. The storage device according to claim 3, wherein the stop unit comprises an annular body arranged in the recess and/or if movement of the retaining bolt from the direction of the storage surface into the recess is limited by the head section on the side facing the storage surface of the annular body, if the retaining bolt comprises a sliding section adjacent to the head section, which has an outer surface that rebounds with respect to the head section and whose diameter is perpendicular to the inner diameter of the head section of the annular body, and if the retaining bolt comprises a foot section that is temporarily or permanently fixed to the head section of the end of the sliding section, whose diameter perpendicular to the transfer direction is greater than the inner diameter of the annular body and sits in the head section of the side of the annular body facing away in its holding position.

5. The storage device according to claim 1, wherein at least one slotted guide system, which comprises a slot formed by at least one groove on the retaining bolt, in particular on the sliding section of the retaining bolt, and which comprises at least one pin-like projection fixed in the recess and which engages in the slot, in particular wherein the pin-like projection on the annular body, in particular on the side facing the sliding section of the retaining bolt, is fixed.

6. The storage device according to claim 5, wherein the slotted guide element of the stop unit, wherein the pin-like projection is arranged in its starting position on starting position stop on the slot and the retaining bolt is prevented from moving in the direction of the recess, wherein the retaining bolt for releasing the pin-like projection from the starting position stop can be moved in the direction of the recess and guided in a release area of the slot, wherein the retaining bolt can be moved to arrange the pin-like projection in a stop position on the slot in the direction of the recess and wherein the retaining bolt can be moved to arrange the pin-like projection on the starting position towards the recess until an estimate basic position has been reached and can be moved from the estimate basic position towards the recess until the basic stop position has been reached.

7. The storage device according to claim 1, wherein at least one of the multiple recesses runs through the panel body and/or the retaining bolt comprises a cavity running parallel to the transfer direction, which is accessible from the outside via an opening on the opposite end of the retaining bolt to the head section.

8. The storage device according to claim 7, wherein a substantially closed surface comprising a floor plate with a closed surface transverse to the transfer direction, which can be temporarily or permanently fixed to the table or panel-like storage medium on the storage surface on the opposite side of the storage medium and by which at least one of the multiple recesses on the side of the plate body facing away from the contact surface is closed in whole or at least in sections to the outside.

9. The storage device according to claim 1, wherein the clamping device comprises a spring which is supported with one end on the base plate and the other end on the retaining bolt, in particular where the end supported on the retaining bolt is positioned in the opening of the retaining bolt.

10. The storage device according to claim 1, wherein the coupling point of the head section of the retaining bolt comprises at least a rotationally symmetrical, rear grip region, which is formed by a recess transverse to the transfer direction in which the outer surface of the head region is parallel or oblique to the transfer direction.

11. The storage device according to claim 1, wherein at least one plug-like locking element can be positioned in the recess, which closes the recess from the direction of the storage surface outwards in the assembled state and which continues freely in the assembled state of the storage surface of the storage medium with a locking surface accessible from the outside or jumps back in the direction of the recess with respect to the storage surface.

12. The storage device according to claim 1, wherein the locking element on the locking surface and/or the head section of the retaining bolt on the end face comprises a recess with a rounded or angular cross-section with respect to the transfer direction, and into which a tool for manual or automatic actuation can be inserted.

13. The storage device according to claim 12, wherein at least one plug element, which can be positioned in the recess in the end face of the head section of the retaining bolt and/or in the recess in the locking surface of the locking element and which allows the end face or the locking surface with an end portion to continue seamlessly in the direction of the recess and/or if the storage device comprises at least one cover element that can be positioned in the recess in the end face of the head section of the retaining bolt and/or in the recess in the locking surface of the locking element and which sits fully or in part transversely to the transfer direction.

14. The storage device according to claim 1, wherein at least one sealant, which can be positioned in the recess, in particular on a region adjacent to the storage surface, which is arranged on the head section of the retaining bolt and/or the locking element, and through which a gap between the retaining bolt and recess or between the locking element and recess and/or at least one overpressure unit whose fluid passage leads into at least one recess, and through which the fluid introduced via the fluid passage in the recess can be pressurised.
